(19) United States
(12) Patent Application Publication
(10) Pub. No.: US 2023/0271352 A1
(43) Pub. Date: Aug. 31, 2023

(54) METHOD FOR PRODUCING A COLD-CASTING MOULD, AND USE OF A COLD-CASTING MOULD FOR THE PRODUCTION OF MOULDED PARTS, IN PARTICULAR DENTURES

(71) Applicant: WDT-WOLZ-DENTAL-TECHNIK GMBH, Bad Sobernheim (DE)

(72) Inventor: Stefan Wolz, Bad Sobernheim (DE)

(21) Appl. No.: 17/768,995

(22) PCT Filed: Oct. 20, 2020
(86) PCT No.: PCT/EP2020/079500

§ 371 Date: Feb. 8, 2023

(30) Foreign Application Priority Data
Oct. 21, 2019 (DE) 10 2019 128 336.1

(51) Int. Cl. B29C 33/38; A61C 13/20

(52) U.S. Cl. CPC B29C 33/3842; B29C 33/3835; A61C 13/20; B29C 2033/385; B33Y 10/00

(57) ABSTRACT

A method for producing a cold casting mold (100) for producing dental molded parts (210) from a mixing compound (200), wherein the cold casting mold (100), having a cavity (110) that corresponds geometrically to the dental molded part (210), is additively constructed from a starting material (150) by means of a 3D printing method on the basis of a digital data set based on a three-dimensional model of the oral cavity of a patient and at least one first opening (111) that opens into the cavity (110) for filling with the mixing compound (200). The invention also relates to such an additively constructed cold casting mold (100) for a method for producing dental molded parts (210) from a sinterable or a light-curing mixing compound (200). The cold casting mold (100) is constructed having at least one second opening that opens into the cavity (110) for discharging gases and/or liquids.

### BACKGROUND OF THE INVENTION

The invention relates to a method for producing a cold casting mold for producing molded parts, in particular dental molded parts, from a mixing compound, wherein the cold casting mold, having a cavity that corresponds geometrically to the molded part, in particular dental molded part, is additively constructed from a starting material by means of an additive material construction method, in particular a 3D printing method using a 3D printer, on the basis of a digital data set based on a three-dimensional model of the oral cavity of a patient and at least one first opening that opens into the cavity for filling with the mixing compound. The invention also relates to the use or the production of such an additively constructed cold casting mold for a method for producing molded parts, in particular dental molded parts, from a sinterable or a light-curing mixing compound.

The production of molded parts by means of computer-assisted methods (CAD/CAM) is known from a large number of technical fields. Dental molded parts, in particular dentures, such as crowns and bridges, but also dental implants and prostheses or parts relevant to orthodontics, such as brackets, are manufactured in many dental practices and dental laboratories by computer-assisted methods (CAD/CAM). First, a digital, three-dimensional model of the oral cavity of a patient is created. The required dentures are planned with the aid of software and the created data set is transferred to a milling machine, for example, which mills the finished dentures out of a blank. The blanks are usually produced according to a cold casting process, in which a mixing compound is first produced from a ceramic powder or metal powder suitable for dental technology. A pasty mass, a slurry, a suspension, or even a “dry” bulk powder can be used as the mixing compound. A method for producing dentures from dental metal powder is known from EP 2 470 113 B1. In this case, a CrCo dental metal powder is mixed into a slurry, poured cold into a mold, and dried therein. A binder added to the slurry provides sufficient dimensional stability after the drying, so that the dried slurry can be removed from the cold casting mold as a green body and milled into the desired three-dimensional shape using the transferred digital data set. Final (dense) sintering gives the dentures the required hardness and density. Material properties required for approval as dental molded parts are permanently defined on the basis of national and/or international standards. Such cold casting methods are only suitable for the production of blanks. The fine, complex shapes of the actual dentures are then milled out of the blank by machining. Teachings on metal or ceramic slurries for dental technology are prior art and can be found, for example, in the documents EP1658018 B1, EP1047355 B1, WO 2013007684 A, EP1558170 B1, and EP1885278 B1. Information on their conditioning can be found in the documents DE 10 2005 023 727 B4 and DE19801534 A1. Carrying out the final dense sintering is also adequately described in the prior art; corresponding methods and sintering furnaces can be found in EP 2765950 B1, EP 2844412 A1, WO2011020688 A1.

When using bulk powders as a mixing compound, an additional work step, carrying out isostatic pressing, is usually required to achieve sufficient dimensional stability. High pressure is applied evenly to all sides of the mixing compound for this purpose. Corresponding methods for the production of ceramic dentures from ceramic powders, for example zirconium oxide are also well known from the prior art. A method in which tooth parts are produced from ceramic powder is described in WO 2008/114 142 A1.

The digital, three-dimensional model of the oral cavity is also used for the production of temporary restorations made of plastic. Here, the data set created for the denture is passed on a 3D printer, which constructs the temporary restoration in layers by means of an additive material construction method (3D printing) from plastic starting material.

In the meantime, in addition to plastics, inorganic substances can also be used as starting materials in the field of additive material construction methods. Additive material construction methods such as SLM (selective laser melting), extrusion methods such as FDM (fused deposition molding) and FFF (fused filament fabrication) are known. Additive material construction methods that use the light-curing properties of the starting materials are also known, e.g.: SLA or STL (stereolithography), DLP (digital light processing), LCM (lithography-based ceramic manufacturing).

There have therefore already been initial attempts to produce dentures from metal or ceramic by means of additive material construction methods. A method in which a tooth crown is produced from zirconia by means of an additive material construction method is known from WO 2018/065856 A1. However, 3D printers for metal or ceramic objects are very expensive and/or the printed molded part does not meet the high material requirements to be approved for dental use. In particular, additive material construction methods require a very high proportion of binder in the starting material (approximately 30%), which is why the required final density or final hardness cannot be achieved or is extremely difficult to achieve. An economical implementation of the printing of dental molded parts made of ceramic or metal is not in sight.

WO 2019/210285 A2 discloses another possibility in which the digital, three-dimensional data of the oral cavity is to be used to produce densely sintered dental prostheses with a complex shape using a 3D printer. For this purpose, not the dentures, but a self-destructing mold is to be printed using a 3D printer. A powder mixture made of of two components, a sinterable alumina powder and a powdered binder having a high coefficient of thermal expansion (CTE), is used as the starting material for the printing process. The printed casting mold is filled with a sinterable, dry zirconia bulk powder as a mixing compound. The casting mold is then closed using a cover printed from the same material in order to isostatically press the casting mold together with the zirconia bulk powder located therein at a pressure of 400 MPa. In this method, it is crucial that the bulk powder is free of binders in order to enable uniform pressing. The bulk powder is compacted together with the casting mold and then sintered without removing the mold. During sintering, the binders contained in the mold expand, causing the mold to burst open. The sintering temperature of the mold has to be higher than the sintering temperature of the bulk powder so that the finished sintered molded part is released from the mold. A disadvantage of the disclosed method is, on the one hand, the high costs associated with the 3D printing of the ceramic starting material and the isostatic pressing at extremely high pressures of 400 MPa. However, the use of a ceramic starting material having a sintering temperature higher than that of the bulk powder is crucial for the method described. On the other hand, the possible uses of the method are also limited. The mixing compound used has to be free of binders in order to achieve uniform pressing. In addition, compacting pressing methods, especially isostatic pressing, in which the pressure is to act evenly on the molded part from all sides, are not suitable for mixing compounds having a moisture content of greater than 7%. Liquids are nearly incompressible. To carry out the isostatic pressing, it is necessary to completely enclose the bulk powder within the casting mold closed using the lid. For this reason, any moisture contained in the mixing compound cannot escape.

The object of the present invention is therefore to provide an additively constructed, in particular 3D-printed, cold casting mold which, in comparison to the prior art, is more cost-effective and enables mass production of dental molded parts having complicated anatomical shapes, colorations, and light-refracting surface structures, such as crowns, bridges, jaw implants, abutments, prostheses, etc. At the same time, the possible uses are to be expanded. In particular, the use of a wide variety of mixing compounds made of sinterable and non-sinterable metallic and/or ceramic materials or plastic, either in dry powder form or as a slurry, suspension, or pasty mass, is made possible.

### SUMMARY OF THE INVENTION

The object is achieved by a method for producing a cold casting mold according to claim 1. A method for producing a cold casting mold of the type described in detail at the outset is characterized in that the cold casting mold is additively constructed having at least one second opening, which opens into the cavity and/or leads out of the cavity, for discharging gases, in particular air inclusions, and/or liquids, in particular diluents.

According to the invention, in addition to the first opening provided for filling the cavity with the mixing compound, at least one second opening is formed which, like the first opening, opens into the cavity or leads out of it in a fluid-conducting manner. In principle, it is conceivable to form the first opening and/or the second opening, in particular to drill it, after the additive construction of the cold casting mold has been completed. However, it is advantageous to form the first opening and/or the second opening directly during the additive material construction, so that an additional work step is avoided. Comparable with, for example, (vacuum) bottling systems, it is also conceivable to form the second opening (for venting) during the additive material construction and to form the first opening (for filling) by introducing a filling channel, in particular concentrically, into the second opening. The second opening makes it possible to discharge fluids, i.e., gases and/or liquids, even while the cold casting mold is being filled (comparable to a venting opening when pouring in using a TetraPak®). After filling, to cure and/or solidify the mixing compound, the at least one first opening and/or the at least one second opening remain unclosed, which allows fluids to escape. On the one hand, air inclusions caused by filling the cold casting mold with the mixing compound can thus be discharged, for example. On the other hand, liquids such as diluents contained in pasty, moist, or slurry-like mixing compounds or suspensions can also be discharged from the cavity of the cold casting mold, which enables the mixing compound to dry within the cold casting mold. Due to the formation of the at least one second opening, the cold casting mold constructed additively according to the method according to the invention can not only be used for mixing compound having any moisture content, the at least one second opening also allows venting when using a bulk powder, which can be supported, for example, by shaking.

According to one preferred embodiment of the invention, at least one wall of the cold casting mold that delimits the cavity is therefore completely or in regions additively constructed having a plurality of second openings that open into the cavity and penetrate this wall, for discharging gases, in particular air inclusions, and/or liquids, in particular diluents.

In that one or more walls of the cold casting mold are penetrated with a plurality of second openings adjacent to one another, a sieve-like surface may be formed which, on the one hand, enables the passage of liquids and gases, but on the other hand holds back solids. The diameter of the respective second openings is preferably smaller than the particle size and/or the size of particle agglomerates that form in the powder contained in the mixing compound, such as metal powder, ceramic-glass ceramic powder, or plastic powder.

In a refinement of this embodiment, the plurality of second openings are therefore also formed as pores and/or capillaries which penetrate the wall, so that the wall has porous and/or hygroscopic properties, either completely or in regions.

Such an embodiment also has the advantage that moisture contained in the mixing compound is taken up or absorbed by the adjoining porous and/or hygroscopic wall and is preferably transported away from the interior, in the direction of the atmosphere surrounding the cold casting mold or away. This effect can be aided by increasing the ambient temperature surrounding the cold casting mold or other measures to reduce the ambient humidity, by which drier ambient air is created.

It is also advantageous to produce the cold casting mold from different starting materials having physical properties differing from one another. For example, the ability of the porous and/or hygroscopic areas to absorb moisture can be increased by way of a suitable starting material. Other regions or structures of the cold casting mold, such as filling channels, compensating volumes, or support structures can be formed by selecting a different starting material having different properties, e.g., water solubility, color, transparency, etc.

In order to facilitate the filling of the cold casting mold, for example by means of a syringe or a cannula or a similar tool, the cold casting mold can be additively constructed having a filling channel adjoining the at least one first opening in a fluid-conducting manner.

The filling channel is preferably integrally formed with the cold casting mold. The filling channel enables in particular a pressurized filling of the cold casting mold, for example by injection molding.

In a refinement, the filling channel is connected in a fluid-conducting manner to at least one compensating volume for storing mixing compound.

The compensating volume is preferably also additively constructed integrally with the cold casting mold. In particular when using mixing compound having a higher moisture content and/or in the case of air inclusions, the compensating volume acts as a kind of reservoir and allows the mixing compound to run or trickle down to compensate for the volume loss caused by the escape of gases and/or liquids via the at least one second opening from the cavity.

According to an alternative variant of the invention, the cavity of the cold casting mold can be filled more quickly and/or more evenly by additively constructing the cold casting mold having two or more first openings, each opening into the cavity, for simultaneous or staggered filling with mixing compound.

Because two or more first openings provided for filling open into the cavity at different positions, filling with different mixing compounds can also take place at different positions of the cavity, for example. If the additional first openings are not used for filling, they can function as second openings for discharging fluids.

An organic material, in particular an organic wax and/or a polymer and/or a plastic, is particularly advantageously used as the starting material for additively constructing the cold casting mold, so that the cold casting mold can be plasticized and/or thermally and/or thermochemically decomposed.

Organic materials such as waxes and/or polymers and/or plastics are significantly easier and therefore more cost-effective to use in additive material construction methods, for example 3-D printing. The heat resistance of plastics is comparatively low, so that the additively constructed cold casting mold made of an organic material can be plasticized or even decomposed thermally and/or thermochemically, in particular by pyrolysis and/or combustion. For structures and/or walls of the cold casting mold that do not delimit or directly adjoin the cavity, in particular for support structures, filling channels, compensating volumes, etc., a starting material having a lower melting point, for example wax, can advantageously be used than for the walls of the cold casting mold that delimit the cavity, which are then additively constructed, for example, from polymers or plastics. In this way, during the plasticizing or decomposition of the cold casting mold, in particular stresses occurring as a result of heat, which could result in damage to the molded part, can be reduced or even completely avoided. The organic starting material can contain small additions of inorganic materials. For example, it is common to admix inorganic additives to plastics. However, the proportion of organic components is always higher than the proportion of inorganic components.

The organic material used for additively constructing the cold casting mold preferably has a melting point and/or a decomposition temperature in a temperature range from 40° C. to 300° C., preferably 60° C. to 300° C.

The melting temperature or the melting temperature range of the cold casting mold is therefore below the melting and/or sintering temperature of the mixing compounds typically used. The decomposition temperature, i.e., the temperature at which thermal and/or thermochemical decomposition of the cold casting mold begins, is also advantageously below the melting and/or sintering temperature of the mixing compound used.

In a refinement, the organic material used for additively constructing the cold casting mold can be plasticized by the action of heat, in particular at a temperature in a temperature range from 35° C. to 300° C., preferably 50° C. to 300° C., and/or can be decomposed thermally by pyrolysis and/or thermochemically by combustion by the action of heat, in particular at a temperature in a temperature range from 200° C. to 650° C. A material group having a particularly low heat resistance is represented, for example, by waxes. By using a waxy, organic material, a softening or plasticizing of the cold casting mold can already be achieved from a temperature of approximately 35° C.

The thermal and/or thermochemical decomposition can preferably be continued completely and/or at high temperatures in a sintering temperature range from 1300° C. to 2500° C., so that a residue-free or at least almost residue-free dissolution of the cold casting mold is made possible by the action of heat.

Alternatively, according to one advantageous embodiment, however, mechanical destruction of the cold casting mold can already be provided during the additive material construction method by additively constructing at least one wall delimiting the cavity of the cold casting mold having a predetermined breaking point, in particular having a reduced wall thickness in regions.

The proposed production method is based on three-dimensional, digital data, in particular of the oral cavity of a patient. The geometric shape data derived from this for molded parts, in particular for dental molded parts, are used directly in the additive material construction method in the geometric design of the cavity of the cold casting mold. In order, for example in dental technology, to guarantee a precise fit of dental molded parts, in particular crowns, bridges, dental implant parts, and/or prostheses in the oral cavity of the patient, the digital data set for the geometric design of the cavity of the cold casting mold therefore preferably includes a sintering and/or hardening-related volume shrinkage of the mixing compound. Depending on the mixing compound used, a corresponding volume shrinkage during curing or solidification and/or sintering of the mixing compound is to be taken into consideration, the cavity of the cold casting mold is to be designed having a correspondingly adapted (larger) initial geometry. For example, for mixing compounds containing ceramic powder, sintering shrinkage in a range from 25% to 50%, for mixing compounds containing sol and nano zirconium oxide particles in a range from 50% to 95% and for mixing compounds containing metal powder, sintering shrinkage in a range from 8% to 25% is to be taken into consideration, each in relation to the initial geometry. For the curing of the mixing compound by light and/or drying, a volume shrinkage of approximately 2% to 20% in relation to the initial geometry is to be taken into consideration. A volume shrinkage in a range from 1% to 10%, in relation to the initial geometry, can also be taken into consideration for the cold casting mold itself for the production of the molded part. The cold casting mold produced according to the method according to the invention enables molded parts, in particular dental molded parts, to be produced inexpensively from a wide variety of mixing compounds.

The cold casting mold according to the invention has at least one first opening opening into the cavity for filling with the mixing compound and is characterized by at least one second opening opening into the cavity for discharging gases, in particular air inclusions, and/or liquids, in particular diluents.

In one embodiment, the cold casting mold has an organic material, in particular an organic polymer or a plastic having a melting point and/or a decomposition temperature in a temperature range from 40° C. to 300° C., in particular from 60° C. to 300° C., so that the cold casting mold can be plasticized, in particular at a temperature in a temperature range from 35° C. to 300° C., in particular from 50° C. to 300° C. and/or can be thermally and/or thermochemically decomposed, in particular at a temperature in a temperature range from 200° C. to 650° C.

Filigree, thin-walled structures are often required in dental molded parts such as crowns, bridges, dental implant parts, and/or prostheses. High sintering temperatures are required especially for the production of dental molded parts made of ceramic or metal. In order to avoid damage to the molded part due to the thermal expansion of the cold casting mold, the linear, thermal expansion of the cold casting mold is advantageously at most 10%, preferably at most 3%, and particularly preferably at most 0.8% in relation to its initial geometry, wherein the maximum thermal expansion of the cold casting mold is reached at a temperature of less than or equal to 240° C., preferably less than or equal to 200° C., more preferably less than or equal to 150° C., and particularly preferably less than or equal to 100° C. Preferably, the coefficient of thermal expansion (CTE value) of the mixing compound can be adjusted, taking into consideration the respective CTE values of the metal, ceramic, or glass-ceramic powder used, by way of the proportions of polyelectrolytes and binders (polymers) and the CTE value of the cold casting mold, so that cold casting mold and mixing compound are subject to a similar or identical thermal expansion. Additionally or alternatively, the mechanical stability of the mixing compound (in the green body state) can be increased by increasing the proportion of binder.

In order to achieve the dimensional accuracy of the cold casting mold required for dental molded parts, even with pressure filling methods, the cold casting mold has a Shore hardness of at least 15 according to Shore A and/or of at least 10 Shore D and a modulus of elasticity of at least 5 MPa. The walls delimiting the cavity of the cold casting mold preferably each have a wall thickness of at least 0.01 mm. The Shore hardness is a material parameter for elastomers and plastics and is defined in the standards DIN EN ISO 868, DIN ISO 7619-1, and ASTM D2240-00. The modulus of elasticity, also referred to as tensile modulus or elasticity modulus, is defined for plastics in particular according to DIN EN ISO 527-1:2019-12.

An exemplary prototype of a cold casting mold according to the invention, suitable for the production of dental molded parts, was produced according to a stereolithography 3D printing method having the following PHYSICAL PROPERTIES:

| ASTM Method | Property Description | Metric | | Imperial | |
|---|---|---|---|---|---|
| D638M | Tensile Modulus | 2100 | MPa | 305,000 | psi |
| D638M | Ultimate Strength | 44.9 | MPa | 6,500 | psi |
| D638M | Elongation at fracture | 6.1% | | 6.1% | |
| D790M | Flexural strength | 74.3 | MPa | 10,770 | psi |
| D790M | Flexural modulus | 2200 | MPa | 329,000 | psi |
| D224 | Hardness (Shore D) | 85 | | 85 | |
| D256A | Izod impact strength | 0.23 | J/cm | 0.46 | ft lb/in |
| D570-98 | Water absorption | 0.7% | | 0.7% | |
| D648 | HPT @ 0.46 MPa | 59° | C. | 138° | F. |
| | (66 psi) | | | | |
| D648 | HPT @ 1.82 MPa | 50° | C. | 122° | F. |
| | (264 psi) | | | | |

By using a starting material for the additive construction of the cold casting mold, which makes one or more walls delimiting the cavity of the cold casting mold transparent and/or transmissive to UV radiation, optical monitoring of the filling of the cold casting mold is possible. For example, the mixing compound or different mixing compounds can be marked using optical markers, in particular using food coloring. The filling of the cold casting mold can then be monitored automatically using a camera.

In addition, the possible uses of the cold casting mold can also be extended to light-curing mixing compounds, which are light-cured in a correspondingly adapted method for the production of molded parts, in particular dental molded parts, in the interior of the cold casting mold.

The object of the invention stated at the outset is therefore also achieved by a method for producing molded parts, in particular dental molded parts, from a sinterable mixing compound according to claim 20 using a cold casting mold according to the invention according to one of the preceding embodiments, and by a method for producing molded parts, in particular dental molded parts from a light-curing mixing compound according to claim 30 using a cold casting mold according to the invention according to one of the preceding embodiments.

A method according to the invention for producing molded parts, in particular dental molded parts, in particular crowns, bridges, dental implant parts, prostheses, etc. from a sinterable mixing compound, such as dental ceramic or glass ceramic powders or slurries, dental metal powders or slurries, etc., using the cold casting mold according to the invention has the following method steps:
providing and/or producing the cold casting mold having a cavity and at least one first opening opening into the cavity and at least one second opening opening into the cavity,
filling the cavity of the cold casting mold via the at least one first opening with the sinterable mixing compound, and
curing and/or solidifying the sinterable mixing compound in the cavity of the cold casting mold.

Gases and/or liquids contained and/or enclosed in the mixing compound are discharged from the cavity via the at least one second opening both during the filling and during the curing and/or solidifying of the mixing compound. Optionally and after the filling, gases and/or liquids contained and/or enclosed in the mixing compound can also escape via the at least one first opening, which remains unclosed throughout the course of the method.

Already during the curing and/or solidifying of the mixing compound, or optionally also only after the mixing compound is completely cured, in particular to green body hardness, a
thermal and/or thermochemical decomposition of the cold casting mold is initiated, in particular at a temperature in a temperature range from 200° C. to 650° C. Finally, a
sintering of the mixing compound to final hardness takes place, in particular at a temperature in a temperature range from 900° C. to 2500° C., until a ready-to-use molded part, in particular a dental molded part, such as a denture is obtained. Optionally, the thermal and/or thermochemical decomposition of the cold casting mold can be continued or ended during the sintering.

According to the invention, the claimed production method is carried out using a cold casting mold having at least two openings connected to the cavity in a fluid-conducting manner, wherein the cavity of the cold casting mold is filled via one opening, the first opening, and fluids contained in the mixing compound, for example diluents or fluids enclosed by the mixing compound, for example air inclusions, are discharged from this mixing compound or from the cavity via another opening, the second opening. In the method according to the invention, the at least two openings enable curing and/or hardening even of binder-containing and/or moist or pasty mixing compounds, such as slurries or suspensions.

According to a refinement of the method, the mixing compound is therefore preferably provided as a slurry and/or pasty mass and contains a diluent, in particular water, wherein the mixing compound cures in the cavity of the cold casting mold by drying and a liquid component and/or moisture content of the mixing compound is discharged by means of the at least one or the plurality of second openings from the cold casting mold, in particular is withdrawn from the mixing compound.

In an advantageous method design, the mixing compound comprises a metal powder, in particular a CrCo powder or a ceramic powder, in particular a zirconium oxide powder and/or an aluminum oxide powder or a glass ceramic powder, in particular a lithium disilicate powder and a binder, wherein the mixing compound in a refinement of this method design cures to green body hardness in the cavity of the cold casting mold.

Binder-containing mixing compounds can be cured in the cold casting mold to green body hardness solely by drying, without applying pressure. The use of a binder means that the cost-intensive isostatic pressing known from the prior art can be dispensed with. In contrast to the method also described in the prior art, however, it is then necessary to carry out the curing of the mixing compound with the cold casting mold open (without a “lid”), wherein fluids are discharged via the at least one second opening and, if necessary, additionally also via the at least one first opening from the cavity of the cold casting mold.

Binders are known in many forms from the prior art and consist mainly of organic materials such as resins, surfactants, polyelectrolytes, polymers, and/or waxes, which result in a comparatively low melting point.

In order to achieve a gentle detachment of the cold casting mold from the mixing compound before debinding takes place or before the binder begins to melt, according to a variant of the method, the temperature resistance and/or heat resistance of the cold casting mold, in particular the melting point and/or the decomposition temperature of the cold casting mold, is below the melting point of the binder and/or below the sintering temperature of the metal powder or the ceramic powder.

The use of a thermally and/or thermochemically decomposable cold casting mold is provided for the method according to the invention. The thermal and/or thermochemical decomposition of the cold casting mold is preferably carried out in a sintering furnace, wherein the cold casting mold is opened and placed in the sintering furnace together with the mixing compound located therein. The decomposition of the cold casting mold can already be initiated or carried out completely at a temperature in a range from 200° C. to 650° C. The respective sintering temperatures of the ceramic powders or metal powders contained in the sinterable mixing compounds are in a range between 1200° C. and 2500° C., so that the cold casting mold is completely or almost completely thermally and/or thermochemically decomposed when the finished, i.e., densely sintered molded part, in particular dental molded part is obtained. In this way, the cold casting mold can be removed gently and without damaging the molded part without any additional work steps before or during the sintering process.

An optional method step provides for the mixing compound to be pre-sintered before the actual sintering, in particular at a temperature in a temperature range from 650° C. to 1300° C., in order to remove the binder components before the molded part is compacted to final hardness.

According to a method variant, the decomposition of the cold casting mold can be carried out pyrolytically under oxygen-free conditions. In particular, the cold casting mold is placed for this purpose in a sintering furnace together with the mixing compound contained therein, which enables sintering under vacuum and/or a protective atmosphere. This method variant is particularly suitable for the production of metallic, dental molded parts, for example made of a CrCo alloy, in order to avoid damage to the molded part due to oxidation.

According to another method variant, in particular in order to obtain ceramic, dental molded parts, decomposition of the cold casting mold with supply of oxygen by combustion is also possible.

A method according to the invention for producing molded parts, in particular dental molded parts, from a light-curing mixing compound using a cold casting mold according to the invention comprises the following steps:
providing and/or producing the cold casting mold having a cavity and at least one first opening opening into the cavity and at least one second opening opening into the cavity,
filling the cavity of the cold casting mold via the at least one first opening with the light-curing mixing compound,
curing and/or solidifying the light-curing mixing compound in the cavity of the cold casting mold,

wherein gases and/or liquids contained and/or enclosed in the mixing compound are discharged from the cavity via the at least one second opening. It is also provided according to the invention for producing molded parts, in particular dental molded parts from light-curing mixing compounds, that fluids contained therein can escape via the at least one second opening during the filling and/or curing or solidifying. Especially when using multi-component materials that have to be mixed together during filling, undesired air inclusions often occur. Such air inclusions can escape via the at least one second opening of the cold casting mold while it is still being filled with the mixing compound.

Optionally, thermal and/or thermochemical decomposition of the cold casting mold can be dispensed with. According to the invention, the cold casting mold is separated or detached from the mixing compound along one or more predetermined breaking points of the cold casting mold in order to obtain a ready-to-use molded part in particular, in particular a dental molded part, such as a denture. The predetermined breaking points have preferably already been formed during the production of the cold casting mold, in particular, they can be wall regions having a wall thickness that is less than that of the other wall regions. In particular, by blowing in compressed air or by using an eccentric tool, the cold casting mold can be “torn open” along the predetermined breaking points after the mixing compound has cured and/or solidified and can thus be detached from the molded part.

According to an advantageous design of the method, the mixing compound comprises an organic material, in particular a plastic or a plastic-based composite material, in particular a plastic-based hybrid composite material or nanohybrid composite material. Such composites have hitherto mostly been used in dental technology for fillings or temporary restorations. Especially with nanohybrid composite materials, having a high filler content of fibers or particles, having a particle size in the nanometer range, however, the material properties required for dental molded parts, such as dentures, with respect to hardness and tightness can also be achieved in principle.

In an advantageous variant of the method, the mixing compound cures in the cavity of the cold casting mold by way of a chemical reaction, for example by means of a two-component binder. The chemical reaction can be started by the action of heat and/or the removal of moisture. The chemical reaction is particularly preferably triggered by the action of light, wherein the walls delimiting the cavity of the cold casting mold are transparent and/or transmissive to UV radiation and the cold casting mold is irradiated using a light source, in particular a UV lamp.

The mixing compound in the cavity of the cold casting mold is preferably cured to the desired final hardness, i.e., the hardness of the finished molded part, before the cold casting mold is detached or removed.

The following description paragraphs contain advantageous method variants which can be used both for the production according to the invention of molded parts from sinterable mixing compounds and also the production according to the invention of molded parts from chemically-curing, in particular light-curing mixing compounds.

For example, the cold casting mold, in particular the walls of the cold casting mold delimiting the cavity, can be coated using a coating agent before the filling with the mixing compound in order to avoid a frictional and/or materially-bonded connection between the cold casting mold and the mixing compound.

It is conceivable to immerse the cold casting mold in a basin having an organic, oily liquid such as petroleum, or alternatively to rinse it using an organic, oily liquid such as petroleum, shortly before or immediately before it is filled with the mixing compound. In this way, a heat-resistant protective layer can be formed in a simple and uncomplicated manner between the walls of the cold casting mold delimiting the cavity and the mixing compound, without closing the first and/or the second opening.

The cavity of the cold casting mold is preferably filled under the action of pressure, wherein an internal pressure present in the cavity is lower than a filling pressure at which the mixing compound is supplied to the cavity.

In practical implementation, two fundamental variants are conceivable for this purpose. With a so-called vacuum filling (implemented in a similar way, for example, in filling systems for bottles), a negative pressure in relation to the environment or a vacuum (0.1 mbar to 0.5 mbar) can be generated within the cavity, due to which the mixing compound is “sucked” into the cavity. After filling, the vacuum or negative pressure is released, so that liquids and/or gases can escape from the at least one second opening and/or the at least one first opening. In this first variant, the filling pressure then corresponds to the ambient pressure. In the second variant, the mixing compound can be injected into the cavity, for example by means of a pump, a screw conveyor, or a simple syringe under pressure, with overpressure in a range, for example, between 1.5 mbar and 10 bar, wherein liquids and gases can already escape from the at least one second opening during the filling. A well-known pressure filling method is, for example, the injection molding method.

After filling, it is advantageous if the mixing compound cures in the cavity of the cold casting mold under the action of heat, wherein the cold casting mold filled with the mixing compound and opened is placed in a drying cabinet or climatic cabinet or a sintering furnace and a temperature is set in a temperature range from 35° C. to 120° C., preferably from 50° C. to 120° C. If necessary, the ambient humidity can also be set to a desired value. ambient humidity in a range from 1% to at most 50% has proven to be advantageous for gentle, uniform, and at the same time rapid drying.

The action of heat and, if necessary, reduced ambient humidity can accelerate the curing and/or solidifying of the mixing compound, for example in the case of a drying process. In particular, the atmosphere or ambient air present in the environment, thus in the drying cabinet or climatic cabinet or in the sintering furnace, is dried, due to which moisture and/or liquid contained in the mixing compound are transported away more quickly from the cavity into the environment. This effect can have considerable influence on the drying times, especially when the walls of the cold casting mold are designed having a porous and/or hygroscopic surface which is penetrated by a large number of second openings in the form of pores and/or capillaries.

According to one method option, the cold casting mold is plasticized after it has been filled with the mixing compound and preferably also after the mixing compound has cured, in order to facilitate detachment of the walls delimiting the cavity from the mixing compound located therein, wherein the cold casting mold filled with the mixing compound is placed in a drying cabinet or climatic cabinet or a sintering furnace and a temperature is set in a temperature range of 35° C. to 300° C., preferably 45° C. to 180° C. The material properties of organic materials or plastics can be utilized here. Before the melting point of the cold casting mold is reached, the organic material, in particular the plastic, begins to soften, as a result of which the cold casting mold can be plasticized or plastically deformed. By blowing in compressed air in a targeted manner, the soft, malleable cold cast mold can be detached from the preferably cured mixing compound.

A particularly fast and uniform filling can take place, for example, according to an embodiment variant of the method, in that the cavity of the cold casting mold is filled with the mixing compound via multiple first openings.

For example, mixing compounds consisting of two or more components can be filled into the cavity of the cold casting mold correspondingly via two or more first openings, for example to prevent premature (light-induced) curing and/or solidifying during filling.

In a refinement of this embodiment variant, the cavity of the cold casting mold is filled via the multiple first openings with respective mixing compounds containing additives for coloring and/or for producing opacity to produce a molded part, in particular a dental molded part having regions of differing coloring and/or opacity.

In this way, the natural appearance of a tooth can be simulated. For this purpose, the different mixing compounds can in particular have various additives, which result in a coloration in the finished molded part according to the standard color ring from Vita, Bad Säckingen, A1 to A4, B1 to B4, C1 to C4 and D1 to D4. A large number of corresponding additives are known from the prior art. Examples of suitable coloring elements are Fe, Mn, Cr, Ni, Co, Pr, Ce, Eu, Gd, Nd, Yb, Tb, Er, and Bi.

Finally, according to an advantageous method variant, the cold casting mold is produced according to one of the method variants of the production method for a cold casting mold described above.

### BRIEF DESCRIPTION OF THE SEVERAL VIEWS OF THE DRAWINGS

Further details, features, feature (sub-)combinations, advantages, and effects on the basis of the invention will be apparent from the following description of a preferred exemplary embodiment and from the drawings. In the figures

FIG. 1 shows a schematic perspective representation of a first exemplary embodiment of a cold casting mold according to the invention having a filling channel and a compensating volume,

FIG. 2 shows a sectional view of the cold casting mold from FIG. 1,

FIG. 3 shows a schematic perspective representation of a second exemplary embodiment of a cold casting mold according to the invention having a filling channel,

FIG. 4 shows a schematic perspective representation of a third exemplary embodiment of a cold casting mold according to the invention having a total of five filling channels,

FIG. 5 shows a schematic perspective representation of a fifth exemplary embodiment of a cold casting mold according to the invention having five filling channels and a mixing means,

FIG. 6 shows a sectional view of the cold casting mold from FIG. 5 having connected filling means,

FIG. 7 shows a schematic side view of a fourth exemplary embodiment of a cold casting mold according to the invention having wall reinforcements and predetermined breaking points,

FIG. 8 shows a schematic perspective representation of a molded part which was produced using a cold casting mold according to the invention,

FIG. 9 shows a sectional view of the cold casting mold from FIG. 4, which is filled with different mixing compounds,

FIG. 10 shows a schematic representation of the cavity of the cold casting mold from FIG. 9 filled with different mixing compounds,

FIG. 11 shows a sectional view of the cold casting mold from FIG. 9, which is filled with different mixing compounds,

FIG. 12 shows a flow chart of an exemplary sequence of the method according to the invention for producing a molded part, in particular a dental molded part,

FIG. 13 shows a schematic sectional view of the cold casting mold from FIGS. 1 and 2, which is electrophoretically filled with mixing compound,

FIG. 14 shows a schematic sectional view of the cold casting mold from FIGS. 1 and 2, which is filled with mixing compound under the action of pressure, and

FIG. 15 shows a schematic representation of a cold casting mold whose cavity corresponds to the shape of a dental prosthesis.

The figures are merely of an exemplary nature and are used only to understand the invention. The same elements are provided with the same reference numerals and are therefore usually only described once.

### DETAILED DESCRIPTION OF THE INVENTION

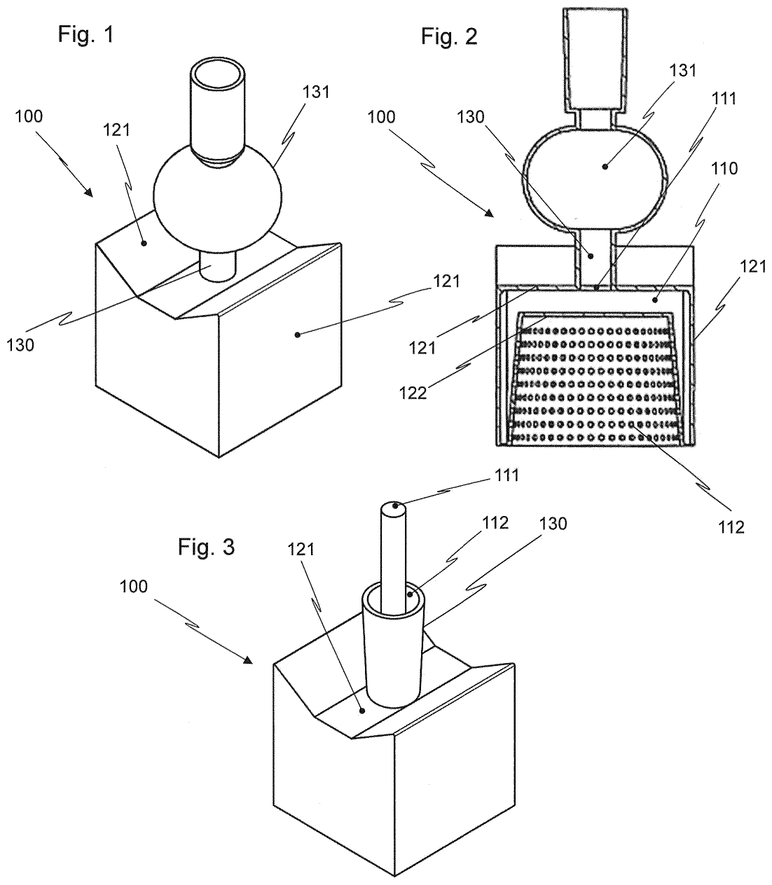

FIGS. 1 and 2 each show a first embodiment of a cold casting mold 100 according to the invention, in a schematic perspective view and in a sectional view, respectively. The cold casting mold 100 is embodied here, for example, in the form of a test specimen, the cavity 110 of which has geometric properties typical for dental molded parts 210, which result in wall thicknesses of the molded part 210 in a range from 0.30 mm to 10 mm. The cavity 110 of the cold casting mold 100 is delimited by the external walls 121 and the inner walls 122 of the cold casting mold 100, so that the finished molded part 210, for example a crown, has an internal cavity 211 (see FIG. 8) which, for example, corresponds to the shape of an abutment, as a result of which the crown can be placed on the abutment. For this purpose, the inner walls 122 form a cylindrical or truncated cone shape. A first opening 111 opens into the cavity 110 and penetrates one of the external walls 121 which are occlusal with respect to the dental molded part 210. The cavity 110 is filled with the mixing compound 200 via the first opening 111. The inner walls 122 are penetrated using a plurality of second openings 112 which, for example, allow fluids 205, 207 and/or air inclusions 208 contained in the mixing compound 200 to escape already during the filling process. After the filling, fluids 205, 207, 208 can optionally also escape via the first opening 111. The plurality of second openings 112 can, as shown here by way of example, penetrate an inner lateral surface of the cavity 110 like a sieve. Alternatively, the plurality of second openings 112 could be embodied in the form of pores and/or capillaries and form a porous and/or hygroscopic surface.

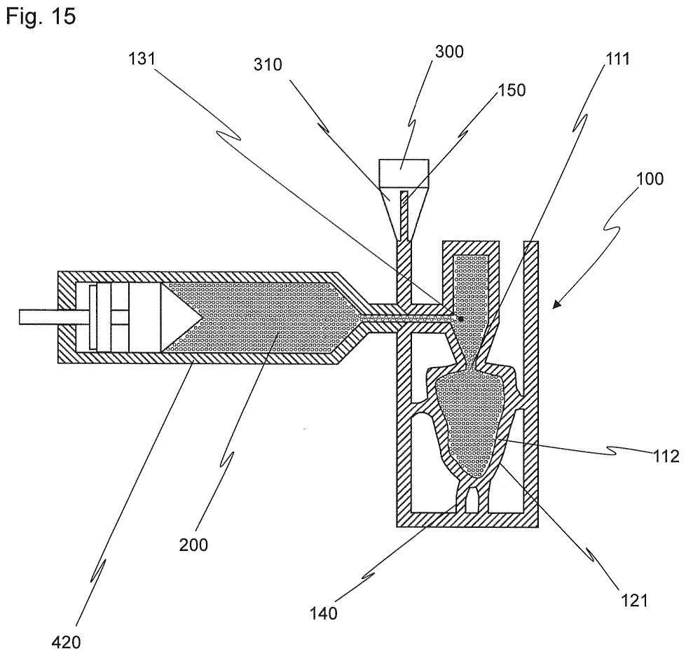

A filling channel 130 having a compensating volume 131 adjoins the first opening 111 in a fluid-conducting manner. Filling means 400, for example injection syringes 420, in particular low-pressure injection syringes (see FIG. 15) or supply lines, such as hoses 410 (see FIG. 6) can be connected to the filling channel 130 to facilitate the filling of the cavity 110 with mixing compound 200. The compensation volume 131 is used as a type of reservoir for the mixing compound 200 so that the volume loss of fluids 205, 207, 208 escaping through the second openings 112 can be compensated for by means of the mixing compound 200 stored in the compensating volume 131. In the exemplary embodiment shown, the cold casting mold 100 is produced integrally with the filling channel 130 and the compensating volume 131.

FIG. 3 shows a schematic perspective representation of a second exemplary embodiment of a cold casting mold 100 according to the invention. The cold casting mold 100 corresponds to the first exemplary embodiment shown in FIGS. 1 and 2, with the exception that the filling channel 130 is formed without the (optional) compensating volume 131 and a channel-like, second opening 112 opens integrally into the occlusal, external wall 121. The filling channel 130 can optionally be implemented integrally or also as an additional part of the cold casting mold (100) and opens with its first opening 111 into the cavity (110). In this variant, the first opening 111 penetrates the second opening 112 concentrically. If required, a separate compensating volume 131 can be connected to the filling channel 130, in particular as part of a filling means 400.

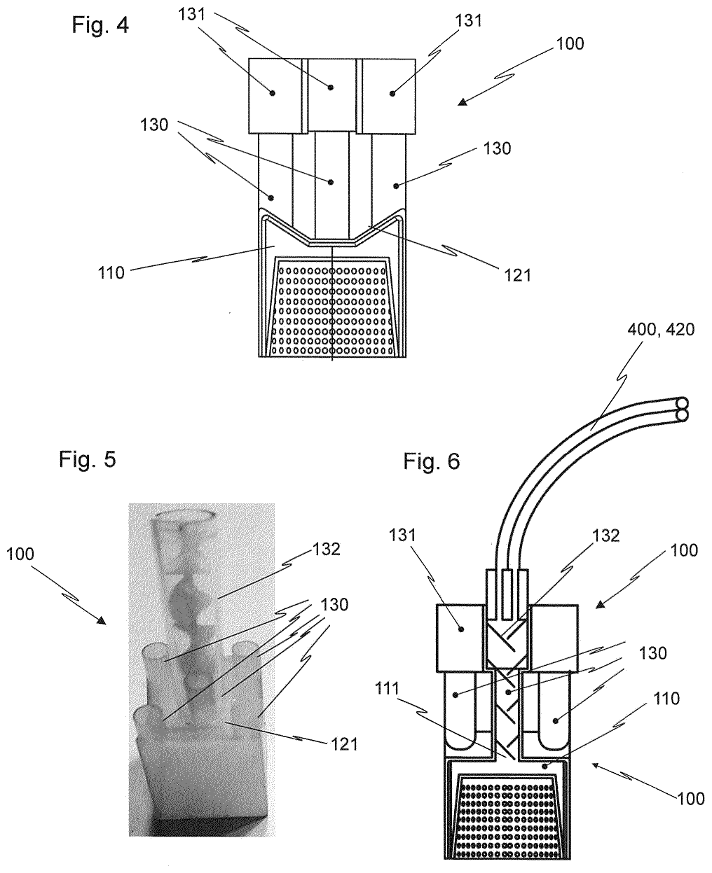

A sectional representation of a third exemplary embodiment of a cold casting mold 100 according to the invention having a total of five filling channels 130 can be seen in FIG. 4. The filling channels 130 each open into the cavity 100 via the first openings 111 penetrating the occlusal, external wall 121 of the cold casting mold 100. Each of the filling channels 130 is connected in a fluid-conducting manner to an associated compensating volume 131. The cold casting mold 100 can optionally be filled with the same or different mixing compound 200 via one or more of the filling channels 130, wherein filling channels 130 not used for filling then function as respective second openings 112 and are used for discharging fluids 205, 207 and/or air inclusions 208 contained in the mixing compound 200. In particular if all filling channels 130 are used, the cavity 110 of the cold casting mold 100 can be filled quickly and particularly evenly.

FIG. 5 shows a schematic perspective representation of a fourth exemplary embodiment of a cold casting mold 100 according to the invention. The cold casting mold 100 has a total of five filling channels 130 which, penetrating the occlusal, external wall 121, open into the cavity 110 via first openings 111. One of the filling channels 130 is provided with a conveying and/or mixing means 132, here in the form of a screw conveyor. This filling channel 130 is formed having a larger cross-sectional area, in particular a larger diameter, than the four other filling channels 130. According to the illustrated figure, the conveying and/or mixing means 132 is pushed as an additional component into the filling channel 130, which is preferably embodied integrally with the cold casting mold 100. The conveying and/or mixing means 132 can particularly advantageously be additively formed directly in the interior of the filling channel 130 during the production of the cold casting mold 100.

FIG. 6 shows the cold casting mold according to FIG. 5 in a sectional view having additional, respective compensating volumes 131 which connect to the respective filling channels 130 in a fluid-conducting manner. A filling means 400 is connected via two hoses 420 to the filling channel 130 containing the conveying and/or mixing means 132. The mixing compound 200 is supplied to the cold casting mold 100 via the hoses 420. The exemplary embodiment shown here is particularly well suited for mixing compounds 200 which are composed of, for example, two components. The components can first be supplied separately to the filling channel 130 via the two hoses 420 and mixed with one another there by means of the conveying and/or mixing means 132 before the mixed mixing compound 200 enters the cavity 110 through the first opening 111.

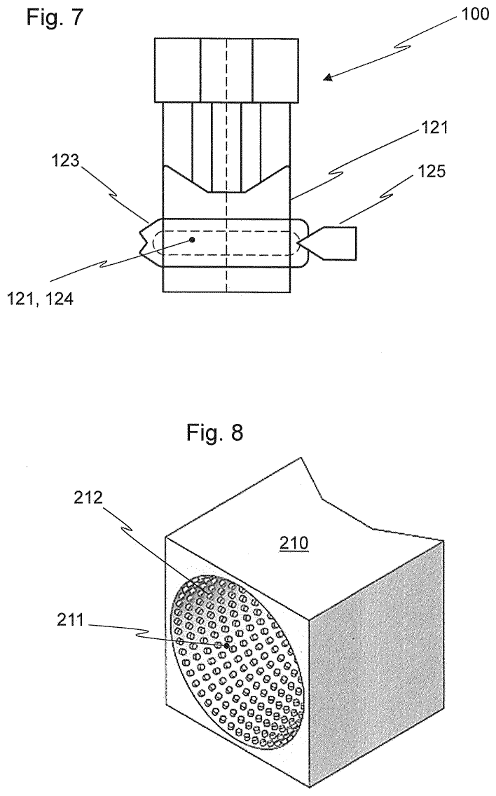

A fifth exemplary embodiment of a cold casting mold 100 according to the invention can be seen in FIG. 7 in a schematic side view. Along the external walls 121 delimiting the cavity 110, the cold casting mold 100 is integrally formed with two wall reinforcements or projections 123, each like a flange. The section of the corresponding external wall 121 located between the wall reinforcements 123 is produced having a lesser wall thickness than the wall reinforcements 123 and is therefore used as a predetermined breaking point 124. By inserting an eccentric tool 125 between the two wall reinforcements 123, the cold casting mold 100 can be “levered open” along the predetermined breaking point 124 in order to detach the cold casting mold 100 from the mixing compound 200 cured therein.

The mixing compound 200 cured to the final hardness required for dental molded parts 210 can be seen in FIG. 8 is a finished molded part 210, which was produced using the cold casting mold 100 designed as a test specimen. The molded part 210 has wall thicknesses in a range from 0.3 mm to 10 mm. A lower, apical section of the molded part 210 is formed having a recess 211, the shape of which corresponds to the shape of an abutment for placing a dental molded part 210, for example a crown. The inward facing walls of the recess 211 are provided with a nubby surface 212 due to the plurality of second openings 112 which penetrate the inner walls 122 of the cold casting mold 100 in a sieve-like structure (see FIG. 2). The nubby surface 212 improves the hold between the dental molding 210, for example a crown and, for example, the abutment.

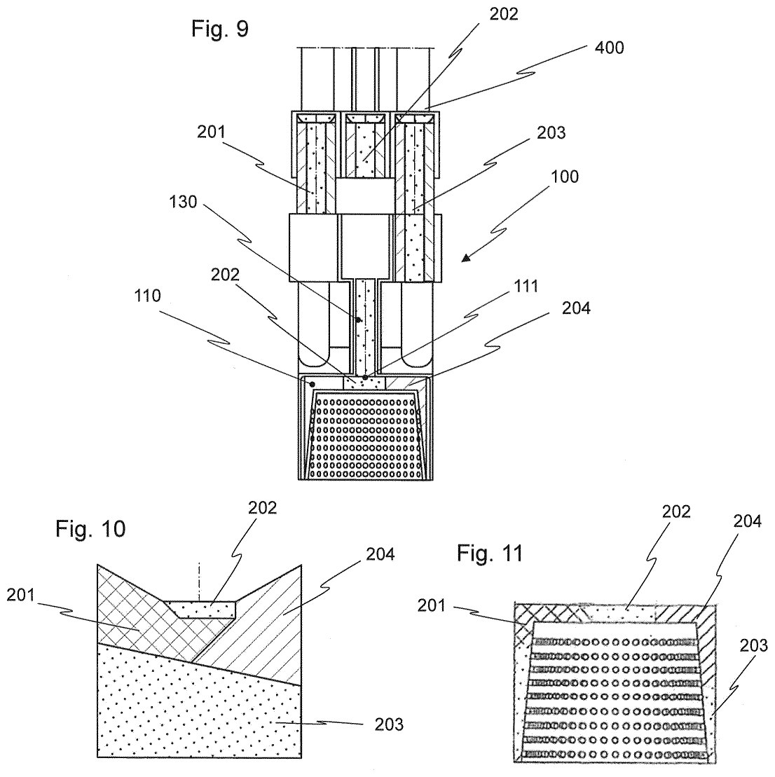

FIG. 9 shows the cold casting mold 100 from FIG. 4 in a sectional view. The cavity 110 of the cold casting mold 100 is filled here with different mixing compounds 201, 202, 203, 204 via a filling means 400. The mixing compounds 201, 202, 203, 204 each contain additives that are suitable for coloring and/or producing opacity of the finished molded part 210. Each of the mixing compounds 201, 202, 203, 204 is preferably filled into the cavity 110 via its own filling channel 130 and the respective first opening 111 adjoining it.

FIGS. 10 and 11 each show a schematic sectional view of a cavity 110 filled with different mixing compounds 201, 202, 203, 204. For example, the lower, apical section of the cavity 110 can be filled with a third mixing compound 203, two outer, occlusal sections with a first mixing compound 201 and a fourth mixing compound 204, respectively, and an occlusal section in between with a second mixing compound 202. After the curing and/or solidifying to final hardness, the finished dental molded part 210 then has regions or sections of different colors or tooth colors and/or different opacities or transparencies.

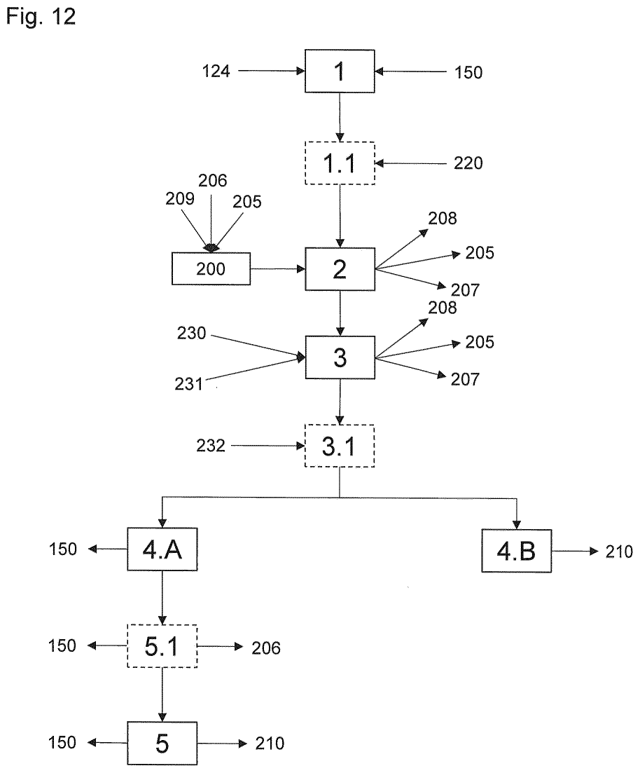

FIG. 12 shows a flow chart of an exemplary sequence of the method according to the invention for producing a dental molded part 210. For this purpose, a cold casting mold 100 is first provided or produced (1). The cold casting mold 100 is constructed by means of an additive material construction method, for example using a 3D printer, wherein the cold casting mold 100 has at least one first opening 111 and at least one second opening 112. A thermally and/or thermochemically decomposable plastic is preferably used as the starting material 150. Optionally, the cold casting mold 100 can already be formed having one or more predetermined breaking points 124 during production. Optionally, the cold casting mold 100 can be coated with a coating agent 220 before it is filled with the mixing compound 200 (1.1). Petroleum, for example, is suitable as the coating agent 220, wherein the cold casting mold 100 is preferably immersed in a basin containing petroleum. The cold casting mold 100 is then filled with the mixing compound 200 (2). Depending on the desired molded part 210, the mixing compound 200 comprises a ceramic, a metal, or a plastic powder 209, which is suitable for the production of dental molded parts. The respective powder 209 is preferably mixed with a diluent 205, for example water or an organic solvent, to form a slurry or a pasty mass, admixed with a binder 206, and conditioned before use. The mixing compound 200 is filled into the cavity 110 of the cold casting mold 100 via the at least one first opening 111. Fluids 207 contained in the mixing compound 200, in particular the diluent 205 or air inclusions 208, can already escape via the at least one second opening 112 during the filling. After the filling, the mixing compound 200 cures inside the cold casting mold 100, more precisely in its cavity 110 (3). In order to accelerate curing, the cold casting mold 100 is placed, for example, in a drying cabinet or climatic cabinet to set a desired ambient humidity of the environment, and heat 230 is applied, so that the liquid components of the mixing compound 200 dry or evaporate more quickly. Here, fluids 207, diluents 205, or air inclusions 208 can continue to escape via the at least one second opening 112 and optionally also via the at least one first opening 111. For the production of dental molded parts 210 from plastic, the cold casting mold 100 is made transparent and is exposed to light 231, in particular UV light. In the case of dental plastic, curing in the cold casting mold 100 to final hardness is possible. For the production of ceramic or metallic dental molded parts 210, the curing in the cold casting mold 100 is preferably carried out up to green body hardness. The stability of the green body can be achieved by the binder 206 used.

After the curing, the cold casting mold 100 can optionally be plasticized (3.1). For this purpose, the cold casting mold 100 is placed in a sintering furnace together with the hardened mixing compound 200 located therein and a temperature in a range from 35° C. to 300° C., in particular from 50° C. to 300° C., is set inside the sintering furnace. The plastic of the cold casting mold 100 softens and can, for example, be “inflated” by blowing in compressed air 232 and detached from the mixing compound 200. In the case of a dental plastic molded part 210, the cold casting mold 100 is opened by the action of mechanical force along one or more predetermined breaking points 124 formed during production (4.B) and the finished dental molded part 210 is removed.

For the production of ceramic or metallic dental molded parts 210, the cold casting mold 100 is thermally or thermochemically decomposed (4.A) before or while the mixing compound 200 cures to final hardness. For this purpose, the cold casting mold 100 is placed in a sintering furnace together with the mixing compound 200 located therein and thermal decomposition or pyrolysis in the absence of oxygen or thermochemical decomposition or combustion with oxygen at a temperature in a temperature range from 200° C. to 650° C. is initiated, during which the starting material 150 is completely or almost completely dissolved. At a temperature in a temperature range from 650° C. to 1300° C., the mixing compound 200 can optionally be pre-sintered (5.1), wherein the binder 206 evaporates. During the ultimate final or dense sintering (5), the mixing compound 200 is compacted to final hardness at a temperature in a temperature range from 900° C. to 2500° C. and can be removed from the sintering furnace as a finished dental molded part 210. Any remnants of the cold casting mold 100 that are not yet completely decomposed are also decomposed during pre-sintering or final sintering.

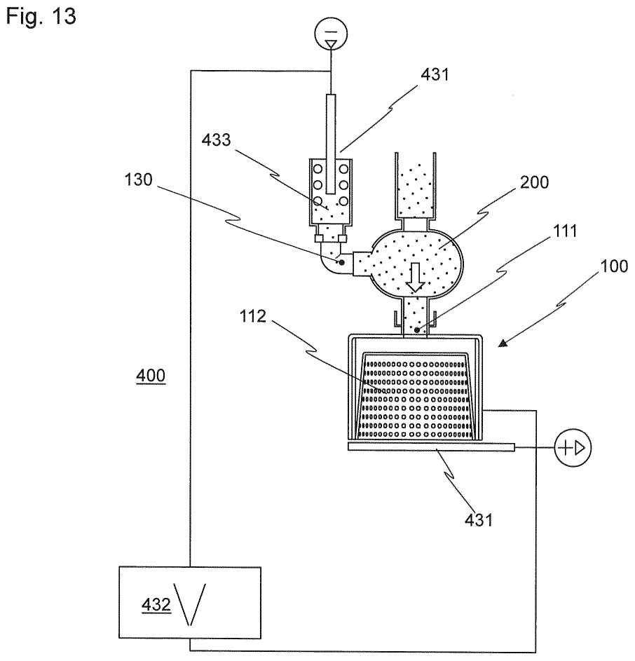

FIG. 13 shows a schematic representation of a possible filling of the cold casting mold 100 from FIG. 2 by means of electrophoresis, in particular electrofiltration. The filling means 400 is designed here in the manner of an electrophoretic device. For electrofiltration it is necessary for the mixing compound 200 to be conductive, for example to comprise a metallic powder, whereas the cold casting mold 100 is optionally produced as an insulator, for example made of plastic or also conductive, made of conductive polymers. The at least one first opening 111 of the cold casting mold 100 is conductively connected to a cathode 430 of the filling means 400 via the mixing compound 200. The plurality of second openings 112 is also conductively connected to an anode 431 of the filling means 400 via the conductive mixing compound 200. By applying a voltage via a voltage source 432, an electric current can be generated which causes a particle transport from the cathode 430 to the anode 431. Experiments have shown that approximately 80% of the diluent 205 already escapes from the mixing compound 200 during the electrophoretic filling of the cold casting mold 100, which results in a considerably shorter process time. The residual moisture content remaining in the mixing compound 200 escapes, as described in detail above, via the plurality of second openings 112, in particular via porous and/or hygroscopic surfaces formed by them, until the mixing compound 200 cures and/or solidifies. The first opening 111 arranged in the region of the cathode 430 or a filling channel 130 adjoining it is preferably provided with a tubular siphon 433 which, in the case of aqueous mixing compounds 200, allows the hydrogen which forms there to escape in order to ensure the homogeneity of the mixing compound 200.

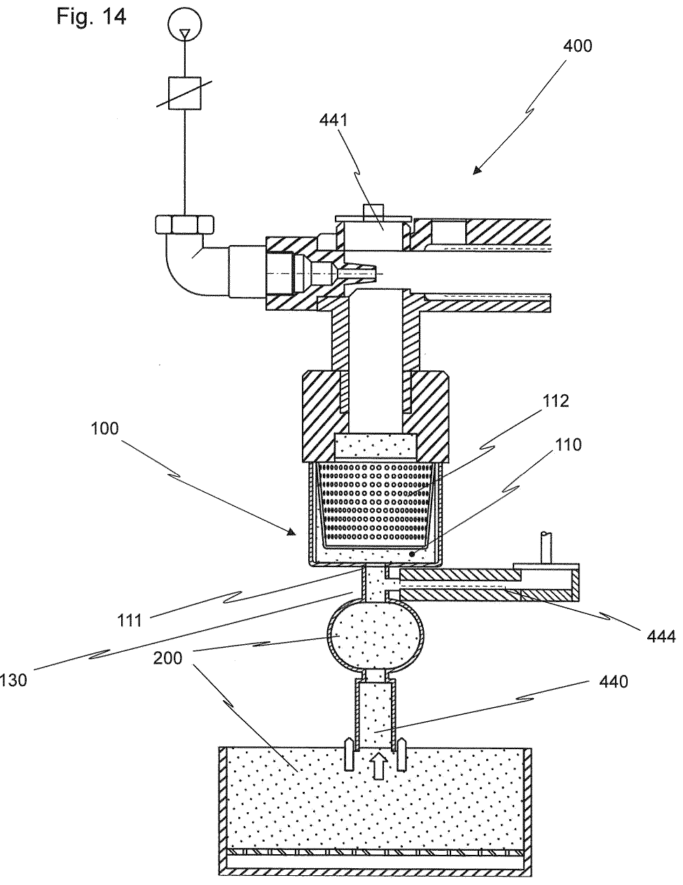

FIG. 14 shows a schematic sectional representation of the cold casting mold 100 from FIGS. 1 and 2, which is filled pneumatically with mixing compound 200 under the action of pressure. This method is particularly suitable for homogeneous filling of powdery mixing compounds 200, but also for slurries or pasty masses. For the filling, the cold casting mold 100 or its cavity 110 is used like a vacuum cleaner bag, wherein the pressure present within the cavity 110 is lower than the ambient pressure. This can either be implemented by the mixing compound 200 being supplied to the cavity 110 via a pressurized conveying line 440 of the filling means 400 embodied here as a pressure device. The mixing compound 200 can be introduced into the delivery line 440 with the aid of rotary valves, pressure vessels, and/or pressure conveying systems.

Alternatively or additionally, a vacuum can also be generated in the cavity 110 of the cold casting mold 100, as a result of which vacuum conveying or also suction conveying of the mixing compound 200 is implemented. A vacuum is generated centrally or decentrally using a vacuum generator 441 in order to suction in mixing compound 200 via the at least one first opening 111 and to transport it into the cavity 110 of the cold casting mold 100. The mixing compound 200 is held back in the interior of the cavity 110 via the plurality of second openings 112 or the wall sections lying between them. The conveying air 442 used to convey the mixing compound 200 passes through the plurality of second openings 112 and is supplied from the environment via a particle filter 443. The control of the filling is simplified via a bypass channel 444 which is connected in a fluid-conducting manner to the filling channel 130.

Finally, FIG. 15 shows an exemplary embodiment of the invention, in which the cold casting mold 100 has a cavity 110 which corresponds to the geometry of a dental molded part 210. In addition, a pressure nozzle 310 of a 3D printer 300 is schematically indicated in the figure, by means of which the cold casting mold 100 is additively constructed integrally from the starting material 150. The cold casting mold 100 comprises a first opening 111 which connects to a filling channel 130 in a fluid-conducting manner via a valve-controlled compensating volume 131. The cavity 110 is filled with the mixing compound 200 via the filling channel 130 using a filling means 400, here by way of example an injection syringe 420. Fluids 207 contained in the mixing compound 200 or air inclusions 208 occurring during filling are discharged from the cavity 110 via a plurality of second openings 112. The second openings 112 are formed here as capillaries or pores in the external walls 121 and are therefore not visible to the naked eye. The large number of second openings 112 creates a porous or hygroscopic surface, which conducts fluids 207 or moisture contained in the mixing compound 200 out of the cavity into the external environment.

### LIST OF REFERENCE SIGNS

100 cold casting mold
110 cavity or tool shape
111 first opening
112 second opening
120 wall
121 external wall
122 internal wall
123 wall reinforcement/wall projection
124 predetermined breaking point
125 eccentric tool
130 filling channel
131 compensating volume
132 conveying and/or mixing means
140 support structure
150 starting material
200 mixing compound
201,202,
203,204 mixing compound having additives
205 diluent
206 binder
207 fluids
208 air inclusions
209 powder
210 molded part
211 recess
220 coating agent
230 heat/ambient humidity
231 light
232 compressed air
300 3D printer
310 pressure nozzle
400 filling means
410 hose
420 Injection syringe, in particular low-pressure injection syringe
430 cathode
431 anode
432 voltage source
433 tubular siphon
440 conveyor line
441 vacuum generator
442 conveying air
443 particle filter
444 bypass channel

### Method Steps:

1 providing and/or producing a cold casting mold
1.1 coating the cold casting mold
2 filling the cold casting mold with mixing compound
3 curing and/or solidifying the mixing compound in the cold casting mold
3.1 plasticizing the cold casting mold
4.A thermally or thermochemically decomposing the cold casting mold
4.B mechanically separating cold casting mold and mixing compound
5.1 pre-sintering
5 sintering

1. A method for producing a cold casting mold (100) for producing molded parts (210), from a mixing compound (200), wherein the cold casting mold (100), having a cavity (110) that corresponds geometrically to the molded part (210), is additively constructed from a starting material (150) by means of an additive material construction method, on the basis of a digital data set based on a three-dimensional model and with at least one first opening (111) that opens into the cavity (110) for filling with the mixing compound (200),
characterized in that
the cold casting mold (100) is additively constructed having at least one second opening (112) opening into the cavity (110) or leading out of the cavity (110) for discharging gases.

2. The method as claimed in claim 1,
characterized in that
at least one wall (120) of the cold casting mold (100) delimiting the cavity (110) is additively constructed completely or in regions having a plurality of second openings (112) opening into the cavity (110) and penetrating this wall (120) for discharging gases.

3. The method as claimed in claim 2,
characterized in that
the plurality of second openings (112) are formed in the manner of pores or capillaries penetrating the wall (120), so that the wall (120) has porous or hygroscopic properties completely or in regions.

4. The method as claimed in claim 1,
characterized in that
the cold casting mold (100) is additively constructed having a filling channel (130) adjoining the at least one first opening (111) in a fluid-conducting manner.

5. The method as claimed in claim 4,
characterized in that
the filling channel (130) is connected in a fluid-conducting manner to at least one compensating volume (131) for storing mixing compound (200).

6. (canceled)

7. The method as claimed in claim 1,
characterized in that
an organic material is used as the starting material (150) for additively constructing the cold casting mold (100), so that the cold casting mold (100) can be plasticized and/or thermally and/or thermochemically decomposed.

8. (canceled)

9. (canceled)

10. (canceled)

11. The method as claimed in claim 1,
characterized in that
at least one wall (120) delimiting the cavity (110) of the cold casting mold (100) is additively constructed having a predetermined breaking point (124).

12. The method as claimed in claim 1,
characterized in that
the digital data set based on a three-dimensional model for the geometric design of the cavity (110) of the cold casting mold (100) comprises a sintering and/or hardening-related volume shrinkage of the mixing compound (200).

13. A cold casting mold (100) for producing molded parts (210) from a mixing compound (200), which cold casting mold (100) is integrally produced by means of an additive material construction method, wherein the cold casting mold (100) has a cavity (110) that corresponds geometrically to the molded parts (210) and is created on the basis of a digital data set based on a three-dimensional model, and at least one first opening (111) opening into the cavity (110) for filling with the mixing compound (200),
characterized in that
the cold casting mold (100) has at least one second opening (112) opening into the cavity (110) for discharging gases.

14. (canceled)

15. (canceled)

16. (canceled)

17. (canceled)

18. (canceled)

19. (canceled)

20. A method for producing molded parts (210) from a sinterable mixing compound (200) using a cold casting mold (100) as claimed in claim 13, having the following method steps:
(1) providing or producing the cold casting mold (100) having a cavity (110) and at least one first opening (111) opening into the cavity (110) and at least one second opening (112) opening into the cavity (110),
(2) filling the cavity (110) of the cold casting mold (100) via the at least one first opening (111) with the sinterable mixing compound (200), and
(3) curing or solidifying the sinterable mixing compound (200) in the cavity (110) of the cold casting mold (100),
wherein gases or liquids contained or enclosed in the sinterable mixing compound (200) are discharged from the cavity (110) via the at least one second opening (112),
(4) initiating a thermal or thermochemical decomposition of the cold casting mold (100) at a temperature in a temperature range from 200° C. to 650° C.,
(5) sintering the sinterable mixing compound (200) to final hardness until a molded part (210) is obtained.

21. The method as claimed in claim 20,
characterized in that
the mixing compound (200) is provided as a slurry or pasty mass and comprises a diluent (205), wherein the mixing compound (200) cures in the cavity (110) of the cold casting mold (100) by drying and a liquid component or moisture content of the mixing compound (200) is discharged from the cold casting mold (100) by means of the at least one or the plurality of second openings (112).

22. The method as claimed in claim 21,
characterized in that
the mixing compound (200) comprises a metal powder (209) or a ceramic powder (209) or a glass ceramic powder and a binder (206).

23. The method as claimed in claim 22,
characterized in that
the mixing compound (200) cures in the cavity (110) of the cold casting mold (100) to green body hardness.

24. (canceled)

25. The method as claimed in claim 23,
characterized in that
the mixing compound (200) is presintered (5.1) for debinding.

26. The method as claimed in claim 25,
characterized in that
the melting point or the decomposition temperature of the cold casting mold (100) is below the sintering temperature of the metal powder (209) or ceramic powder (209).

27. (canceled)

28. (canceled)

29. (canceled)

30. A method for producing molded parts (210) from a light-curing mixing compound (200) using a cold casting mold (100) as claimed in claim 13, wherein the method comprises:
(1) providing or producing the cold casting mold (100) having a cavity (110) and at least one first opening (111) opening into the cavity (110) and at least one second opening (112) opening into the cavity (111),
(2) filling the cavity (110) of the cold casting mold (100) via the at least one first opening (111) with the light-curing mixing compound (200), and
(3) curing or solidifying the mixing compound (200) in the cavity (110) of the cold casting mold (100),
wherein gases or liquids contained or enclosed in the light-curing mixing compound (200) are discharged from the cavity (110) via the at least one second opening (112), and
(4) mechanically separating the cold casting mold (100) from the hardened mixing compound (200) along one or more predetermined breaking points (124) in order to obtain a molded part (210).

31. (canceled)

32. (canceled)

33. The method as claimed in claim 30,
characterized in that
the mixing compound (200) cures in the cavity (110) of the cold casting mold (100) due to the action of light, wherein the walls (120) delimiting the cavity (110) of the cold casting mold (100) are transparent or transmissive to UV radiation and the cold casting mold (110) is irradiated using light from a light source (231).

34. The method as claimed in claim 33,
characterized in that
the mixing compound (200) cures in the cavity (110) of the cold casting mold (100) to final hardness.

35. (canceled)

36. (canceled)

37. The method as claimed in claim 34,
characterized in that
the mixing compound (200) cures in the cavity (110) of the cold casting mold (100) under the action of heat, wherein the cold casting mold (100) filled with the mixing compound (200) is placed in a drying cabinet or a sintering oven and a temperature in a temperature range of 30° C. to 120° C., or an ambient humidity in a range from 1% to 50% are set.

38. (canceled)

39. (canceled)

40. (canceled)

41. (canceled)

42. The method as claimed in claim 1,
characterized in that
the cold casting mold (100) is additively constructed with a cavity (110) on the basis of a digital data set based on a three-dimensional model of the oral cavity of a patient, wherein the cavity (110) corresponds geometrically to a dental molded part (210) for producing dental molded parts (210) from the mixing compound (200).
